(19) United States
(12) Patent Application Publication
(10) Pub. No.: US 2020/0190388 A1
(43) Pub. Date: Jun. 18, 2020

(54) WORKOVER FLUID COMPOSITIONS AND METHODS OF USE THEREOF

(71) Applicant: Roger A. Daar, Jr., The Woodlands, TX (US)

(72) Inventor: Roger A. Daar, Jr., The Woodlands, TX (US)

(21) Appl. No.: 16/708,961

(22) Filed: Dec. 10, 2019

Related U.S. Application Data
(60) Provisional application No. 62/778,485, filed on Dec. 12, 2018.

(51) Int. Cl. C09K 8/38; C09K 8/035

(52) U.S. Cl. CPC C09K 8/38; C09K 2208/10; C09K 8/035

(57) ABSTRACT

A composition for use in performing downhole workover operations of boreholes is disclosed. The composition is a mixture of nitrogen gas or carbon dioxide gas, Y-grade fluids mixture and a surfactant foaming agent. In other embodiments, a high density, non-toxic, inert gas compound can be added to the mixture. Alternatively, a flame retardant chemical can be added to the mixture, as well as a gas or chemical additive that alters the mixture's thermal properties. The composition may be further supplemented with organo-silicate nanoparticles.

### BACKGROUND OF THE INVENTION

Conventional workover fluids, also known as “kill” fluids, use aqueous brines, diesel, condensate, water-based muds, and oil-based muds that are pumped down the well in over-balanced pressure operations to reduce tubing head pressure at the surface to zero prior to removing the production tree and installing the blow out prevention (BOP) stack.

When water is present, workover fluids can contribute to a type of reservoir formation damage called “clay swelling”. Clay swelling occurs when clay minerals contained within reservoir rock pore networks contact water that is forced into the reservoir as part of the over-balanced pressure “well kill” operation. After contact with water, these swollen clay minerals can occupy a volume several orders of magnitude greater than their unaltered state. This clay volume expansion creates an annulus of reduced rock permeability surrounding the wellbore, the severity of which depends upon fluid penetration depth, fluid salinity, contact time between fluid and clay minerals, and type of clay minerals.

The permeability damaged annulus with its constricted pore network creates an additional pressure drop that impedes flow from the reservoir into the wellbore and reduces oil and gas well productivity. Removing water from the workover fluid composition removes the means by which clay swelling occurs and should improve post-workover oil and gas production rates.

Workover fluids comprised of diesel or condensate can induce a type of formation damage in gas reservoirs termed “liquid blocking”. Liquid blocking occurs when discrete, immobile diesel or condensate globules are left behind in the reservoir pore network after workover operations. Liquid blocking forms an annulus of reduced relative permeability to gas around the wellbore and like clay swelling, reduces the gas well productivity.

Using brine as a workover kill fluid often introduces sulphate reducing bacteria into the well and “sours” the reservoir with these hydrogen sulfide producing bacteria. Bacteria are introduced when brine storage tanks at any point in the supply chain are not properly cleaned or when untreated stagnant surface water is collected and mixed with brine at the well site.

The only alternative for ensuring no formation damage occurs during workover operations is to snub a well “live”—that is, without any kill fluid to provide back-pressure against the reservoir.

The present invention provides a composition that can be employed as a workover fluid without the adverse effects of conventional workover fluids.

### SUMMARY OF THE INVENTION

In a first embodiment of the invention, the present invention provides for a composition comprising a mixture of nitrogen gas or carbon dioxide gas, Y-grade fluids mixture, and a surfactant foaming agent.

In a second embodiment of the invention, there is disclosed a composition comprising a mixture of nitrogen gas or carbon dioxide gas, Y-grade fluids mixture, a surfactant foaming agent and a high density, non-toxic, inert gas compound.

In a third embodiment of the invention, there is disclosed a composition comprising a mixture of nitrogen gas or carbon dioxide gas, Y-grade fluids mixture, and a flame retardant chemical.

In a fourth embodiment of the invention, there is disclosed a composition comprising a mixture of nitrogen gas or carbon dioxide gas, Y-grade fluids mixture, and an organo-silicate nanoparticle.

In another embodiment of the invention, there are disclosed improved methods for performing downhole reservoir workovers comprising adding and pumping the inventive compositions into an oil or gas well.

In general, Y-grade fluids comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

The advantages therefore in the inventive compositions are that they contain no water, no solid particulate bentonite, and no diesel or condensate. They contain only gaseous and volatile hydrocarbons.

The compositions of the present invention therefore provide improvements over conventional aqueous and oil-based workover fluids. The inventive compositions would inhibit formation damage and the additional pressure drop into the wellbore that is created when workover fluid invades the near wellbore reservoir pore network during workover operations.

The inventive compositions would be less likely to induce clay swelling and better retain near wellbore reservoir permeability.

The inventive compositions would not cause liquid blocking and would better retain near wellbore relative permeability characteristics.

The inventive compositions do not contain solid bentonite particles so that the deleterious effects such as plugging of perforation tunnels, gravel packs and near wellbore reservoir rock pore networks would be eliminated.

The methods of using the inventive compositions as workover fluids would improve production in the oil and gas wells. The use of the Y-grade mixtures could also provide oil well stimulation and increase oil productivity.

The methods using the inventive compositions would provide downhole back-pressure to the reservoir, reduce working surface pressure and improve expected safety performance over that encountered during “live” workover snubbing operations.

The use of the inventive compositions would reduce the risk inherent in using brines as kill fluids and the potential introduction of sulphate reducing bacteria.

### DETAILED DESCRIPTION OF THE INVENTION

In the first embodiment of the invention, the foam physical properties that are required of a particular oil or gas well workover operation may be adjusted by altering the individual components. For example, the desired foam physical properties can be achieved by adjusting the gas/liquid phase volume ratio (i.e., foam quality), altering the gas and/or liquid phase compositions, heating or cooling the foam components entering the well, adding liquid or gas phase chemicals, and/or adding solid phase nanoparticles.

In the second embodiment, the composition of the first embodiment is supplemented with a compound to increase its density and extend its use into deeper, higher pressure reservoirs. The addition of a high molecular weight gas such as sulphur hexafluoride will expand the workover fluid depth capability when the composition is formulated with nitrogen and/or carbon dioxide.

The third embodiment builds from the composition of the first embodiment with the addition of a flame retardant chemical. The addition of flame retardant chemicals will likely improve expected safety performance during workover operations, particularly when addressing situations with high Reid Vapor Pressures.

In the fourth embodiment, the organo-silicate nanoparticles added can alter the wettability of the reservoir thereby combining workover operations with oil well stimulation.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

What is claimed is:

1. A composition comprising a mixture of nitrogen gas or carbon dioxide gas, Y-grade fluids mixture, and a surfactant foaming agent.

2. A composition comprising a mixture of nitrogen gas or carbon dioxide gas, Y-grade fluids mixture, a surfactant foaming agent and a high density, non-toxic, inert gas compound.

3. A composition comprising a mixture of nitrogen gas or carbon dioxide gas, Y-grade fluids mixture, and a flame retardant chemical.

4. A composition comprising a mixture of nitrogen gas or carbon dioxide gas, Y-grade fluids mixture, and an organo-silicate nanoparticle.

5. An improved method for performing downhole oil and gas well workovers comprising adding a composition selected from the group of mixtures comprising a mixture of nitrogen gas or carbon dioxide gas, Y-grade fluids mixture, and a surfactant foaming agent; nitrogen gas or carbon dioxide gas, Y-grade fluids mixture, a surfactant foaming agent and a high density, non-toxic, inert gas compound; of nitrogen gas or carbon dioxide gas, Y-grade fluids mixture, and a flame retardant chemical; and nitrogen gas or carbon dioxide gas, Y-grade fluids mixture, and a higher quality foam, as well as containing gas and/or chemical additives that alter its thermal properties.
